(19) United States
(12) Patent Application Publication
(10) Pub. No.: US 2025/0304098 A1
(43) Pub. Date: Oct. 2, 2025

(54) VEHICLE CONTROL DEVICE, VEHICLE CONTROL METHOD, AND STORAGE MEDIUM

(71) Applicant: HONDA MOTOR CO., LTD., Tokyo (JP)

(72) Inventor: Yuki Kitamura, Tokyo (JP)

(21) Appl. No.: 19/059,732

(22) Filed: Feb. 21, 2025

(30) Foreign Application Priority Data
Mar. 27, 2024 (JP) 2024-050997

(51) Int. Cl. B60W 50/16; B60W 30/12; B60W 50/14; G06V 20/56

(52) U.S. Cl. CPC B60W 50/16; B60W 30/12; G06V 20/588; B60W 2050/143; B60W 2050/146; B60W 2420/403; B60W 2520/10; B60W 2540/106; B60W 2540/12; B60W 2552/30; B60W 2552/53

(57) ABSTRACT

A vehicle control device includes: a recognizer configured to recognize a surrounding situation of a vehicle; a speed operation detector configured to detect a speed operation on the vehicle performed by a driver of the vehicle; a determiner configured to determine whether the vehicle is likely to depart from a traveling lane on the basis of a recognition result from the recognizer; and a controller configured to output a departure alarm to the driver when the determiner determines that the vehicle is likely to depart from the traveling lane. The controller curbs outputting of the departure alarm when a predetermined time has not elapsed after the speed operation has been detected by the speed operation detector.

### CROSS-REFERENCE TO RELATED APPLICATION

Priority is claimed on Japanese Patent Application No. 2024-050997, filed Mar. 27, 2024, the content of which is incorporated herein by reference.

### BACKGROUND

### Field of the Invention

The present invention relates to a vehicle control device, a vehicle control method, and a storage medium.

### Description of Related Art

Recently, countermeasures for providing access to a sustainable transportation system in which vulnerable persons out of traffic participants are considered have been actively studied. In order to realize such countermeasures, focus has been concentrated on research and development for further improving safety or convenience of traffic through research and development on preventive safety technology. In this regard, a technique of setting a steering assist torque to be larger when a curve recognized state in which a driver recognizes a curve in front of a host vehicle is determined than when the curve recognized state is not determined or performing lane keeping control which is one of an alarm outputting operation for preventing departure of the host vehicle from a lane, an information providing operation, an automatic steering operation of the host vehicle, and an automatic brake operation on the basis of a time until the host vehicle reaches a lane boundary line has been recently disclosed (for example, see Japanese Patent No. 5018092 and Japanese Patent No. 6658235).

### SUMMARY

In such preventive safety technology, control against departure of a vehicle from a lane may be excessively performed, and thus there is a problem in that appropriate departure curbing control may not be performed.

In order to solve the aforementioned problem, an objective of the present invention is to provide a vehicle control device, a vehicle control method, and a storage medium that can perform more appropriate departure curbing control according to a driving situation of a driver. Another objective thereof is to contribute to advancement of a sustainable transportation system.

A vehicle control device, a vehicle control method, and a storage medium according to the present invention employ the following configurations.
(1) According to an aspect of the present invention, there is provided a vehicle control device including: a recognizer configured to recognize a surrounding situation of a vehicle; a speed operation detector configured to detect a speed operation on the vehicle performed by a driver of the vehicle; a determiner configured to determine whether the vehicle is likely to depart from a traveling lane on the basis of a recognition result from the recognizer; and a controller configured to output a departure alarm to the driver when the determiner determines that the vehicle is likely to depart from the traveling lane, wherein the controller curbs outputting of the departure alarm when a predetermined time has not elapsed after the speed operation has been detected by the speed operation detector.
(2) In the aspect of (1), the controller curbs outputting of the departure alarm when the predetermined time has not elapsed after the speed operation has been detected while the vehicle is within a predetermined distance before a curved road or is traveling on a curved road and it is determined that the vehicle is likely to depart from the traveling lane.
(3) In the aspect of (1), the speed operation detector detects the speed operation when a brake operation on the vehicle is performed by the driver.
(4) In the aspect of (1), the speed operation detector detects the speed operation when an accelerator operation on the vehicle is performed by the driver and a rate of change of an amount of operation on an accelerator pedal in the accelerating operation is equal to or greater than a threshold value.
(5) In the aspect of (1), the controller curbs outputting of the departure alarm when the predetermined time has not elapsed after the speed operation has been completed and it is determined that the vehicle is likely to depart from the traveling lane.
(6) In the aspect of (1), the speed operation includes a brake operation and an accelerator operation on the vehicle, and the predetermined time is set to the same time for the brake operation and the accelerator operation.
(7) According to another aspect of the present invention, there is provided a vehicle control method that is performed by a computer, the vehicle control method including: recognizing a surrounding situation of a vehicle; detecting a speed operation on the vehicle performed by a driver of the vehicle; determining whether the vehicle is likely to depart from a traveling lane on the basis of the recognized surrounding situation; outputting a departure alarm to the driver when it is determined that the vehicle is likely to depart from the traveling lane; and curbing outputting of the departure alarm when a predetermined time has not elapsed after the speed operation has been detected.
(8) According to another aspect of the present invention, there is provided a non-transitory computer-readable storage medium storing a program, the program causing a computer to perform: recognizing a surrounding situation of a vehicle; detecting a speed operation on the vehicle performed by a driver of the vehicle; determining whether the vehicle is likely to depart from a traveling lane on the basis of the recognized surrounding situation; outputting a departure alarm to the driver when it is determined that the vehicle is likely to depart from the traveling lane; and curbing outputting of the departure alarm when a predetermined time has not elapsed after the speed operation has been detected.

According to the aspects of (1) to (8), it is possible to perform more appropriate departure curbing control according to a driving situation of a driver.

### BRIEF DESCRIPTION OF THE DRAWINGS

FIG. 1 is a diagram illustrating a configuration of a vehicle M in which a vehicle control device according to an embodiment is mounted.

FIG. 2 is a diagram illustrating alarm curbing control according to the embodiment.

FIG. 3 is a flowchart illustrating a first example of an alarm curbing process.

FIG. 4 is a flowchart illustrating a modified example of a departure alarm curbing process according to the first example.

FIG. 5 is a flowchart illustrating a second example of a departure alarm curbing process.

FIG. 6 is a flowchart illustrating a modified example of the departure alarm curbing process according to the second example.

### DESCRIPTION OF EMBODIMENTS

Hereinafter, a vehicle control device, a vehicle control method, and a storage medium according to an embodiment of the present invention will be described with reference to the accompanying drawings.

### Entire Configuration

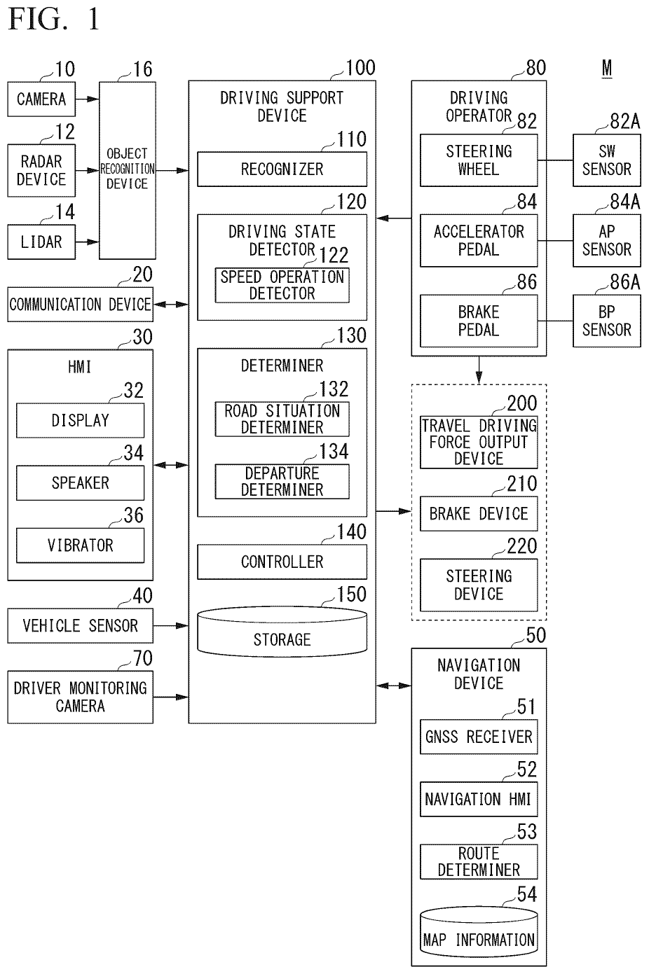

FIG. 1 is a diagram illustrating a configuration of a vehicle M in which a vehicle control device according to an embodiment is mounted. The vehicle M is, for example, a vehicle with two wheels, three wheels, or four wheels, and a drive source thereof is an internal combustion engine such as a diesel engine or a gasoline engine, an electric motor, or a combination thereof. The electric motor operates using electric power generated by a power generator connected to the internal combustion engine or using electric power discharged from a secondary battery or a fuel cell.

For example, a camera 10, a radar device 12, a Light Detection and Ranging (LIDAR) device 14, an object recognition device 16, a communication device 20, a human-machine interface (HMI) 30, a vehicle sensor 40, a navigation device 50, a driver monitoring camera 70, a driving operator 80, a driving support device 100, a travel driving force output device 200, a brake device 210, and a steering device 220 are mounted in the vehicle M. These devices or instruments are connected to each other via a multiplex communication line such as a controller area network (CAN) communication line, a serial communication line, a radio communication network, or the like. The configuration illustrated in FIG. 1 is only an example and a part of the configuration may be omitted or another configuration may be added thereto. The HMI 30 is an example of an “alarm” or a “notifier.” The driving support device 100 is an example of a “vehicle control device.”

The camera 10 is, for example, a digital camera using a solid-state imaging device such as a charge coupled device (CCD) or a complementary metal oxide semiconductor (CMOS). The camera 10 is attached to an arbitrary position on the vehicle M. When a forward view is imaged, the camera 10 is attached to an upper part of a front windshield, a rear surface of a rearview mirror, or the like. The camera 10 images the surroundings of the vehicle M, for example, periodically and repeatedly. The camera 10 may be a stereo camera.

The radar device 12 radiates radio waves such as millimeter waves to the surroundings of the vehicle M, detects radio waves (reflected waves) reflected by an object, and detects at least a position (a distance and a direction) of the object. The radar device 12 is attached to an arbitrary position on the vehicle M. The radar device 12 may detect a position and a speed of an object using a frequency modulated continuous wave (FM-CW) method.

The LIDAR device 14 radiates light (or electromagnetic waves of wavelengths close to light) to the surroundings of the vehicle M and measures scattered light. The LIDAR device 14 detects a distance to an object on the basis of a time from radiation of light to reception of light. The radiated light is, for example, a pulse-like laser beam. The LIDAR device 14 is attached to an arbitrary position on the vehicle M.

The object recognition device 16 performs a sensor fusion process on results of detection from some or all of the camera 10, the radar device 12, and the LIDAR device 14 and recognizes a position, a type, a speed, and the like of an object. The object recognition device 16 outputs the result of recognition to the driving support device 100. The object recognition device 16 may output the results of detection from the camera 10, the radar device 12, and the LIDAR device 14 to the driving support device 100 without any change. The object recognition device 16 may be omitted from the vehicle M. Some or all of the camera 10, the radar device 12, the LIDAR device 14 and the object recognition device 16 are an example of an “outside detection device.”

The communication device 20 communicates with other vehicles near the vehicle M, for example, using a network such as a cellular network, a Wi-Fi network, Bluetooth (registered trademark), or dedicated short range communication (DSRC) or communicates with various server devices via radio base stations.

The HMI 30 presents various types of information to an occupant of the vehicle M and receives an input operation from the occupant. The HMI 30 includes, for example, a display 32, a speaker 34, and a vibrator 36. The display 32 is, for example, a liquid crystal display (LCD) device or an organic electroluminescence (EL) display device. The display 32 displays various images (including a video) according to the embodiment. The display 32 may be configured as a touch panel which is a unified body with an input. The speaker 34 outputs predetermined sound (for example, an alarm). The vibrator 36 causes at least one of a steering wheel 82 included in the driving operator 80, a seat on which an occupant sits, and a safety belt in use to vibrate, for example, on the basis of an instruction from the driving support device 100. For example, the vibrator 36 notifies a driver of the vehicle M (hereinafter referred to as a driver) of a predetermined situation through vibration. The HMI 30 may include a microphone, buzzers, a touch panel, switches, and keys in addition to (or instead of) the display 32, the speaker 34, and the vibrator 36. For example, the HMI 30 may include a switch for switching a driving state of the vehicle M (details of driving control) in response to a driver's operation.

The vehicle sensor 40 includes a vehicle speed sensor that detects a speed of the vehicle M, an acceleration sensor that detects acceleration, a yaw rate sensor that detects a yaw rate (for example, an angular velocity around a vertical axis passing through the center of gravity of the vehicle M), a lateral acceleration sensor (a lateral G sensor) that detects a lateral acceleration (a lateral G) of the vehicle M, a direction sensor that detects a direction of the vehicle M, and a steering angle sensor that detects a steering angle (which may be an angle of turning wheels or may be an operation angle of a steering wheel) of the vehicle M. The vehicle sensor 40 may include a position sensor that detects a position of the vehicle M. The position sensor is, for example, a sensor that acquires position information (longitude and latitude information) from a global positioning system (GPS) device. The position sensor may be a sensor that acquires position information of a global navigation satellite system (GNSS) receiver 51 of the navigation device 50.

The navigation device 50 includes, for example, a GNSS receiver 51, a navigation HMI 52, and a route determiner 53. The navigation device 50 stores map information 54 in a storage device such as a hard disk drive (HDD) or a flash memory. The GNSS receiver 51 identifies a position of the vehicle M on the basis of signals received from GNSS satellites. The position of the vehicle M may be identified or corrected by an inertial navigation system (INS) using the output of the vehicle sensor 40. The navigation HMI 52 includes a display device, a speaker, a touch panel, and keys. The navigation HMI 52 may be partially or wholly shared by the HMI 30. For example, the route determiner 53 determines a route (hereinafter referred to as a route on a map) from the position of the vehicle M identified by the GNSS receiver 51 (or an input arbitrary position) to a destination input by an occupant using the navigation HMI 52 with reference to the map information 54. The map information 54 is, for example, information in which a road shape is expressed by links indicating a road and nodes connected by the links. The map information 54 may include point of interest (POI) information. The map information 54 may include, for example, information of centers of lanes and information of boundaries of lanes such as road marking lines (hereinafter referred to as marking lines) defining a lane. The map information 54 may include road information such as a radius of curvature (or a curvature), a gradient, or a width of a road (or for each lane included in the road), traffic regulation information, address information (addresses and postal codes), facility information, and phone number information. The map information 54 may be updated from time to time by causing the communication device 20 to communicate with another device. The map information 54 may be stored in a storage of the driving support device 100.

The navigation device 50 may perform route guidance using the navigation HMI 52 on the basis of the route on a map. The navigation device 50 may be realized, for example, by a function of a terminal device such as a smartphone or a tablet terminal which is carried by an occupant. The navigation device 50 may transmit a current position and a destination to a navigation server via the communication device 20 and acquire a route which is equivalent to the route on a map from the navigation server.

The driver monitoring camera 70 is, for example, a digital camera using a solid-state imaging device such as a CCD or a CMOS. The driver monitoring camera 70 is attached to an arbitrary position on the vehicle M in a place and a direction in which the head and the upper half (including positions of hands) of a driver sitting on a driver's seat of the vehicle M can be imaged from the front (such that the face of the driver is imaged). For example, the driver monitoring camera 70 is attached to an upper part of a display device which is provided at the center of an instrument panel of the vehicle M. The driver monitoring camera 70 outputs an image obtained by imaging a cabin including the driver of the vehicle M from an installed position thereof to the driving support device 100.

The driving operator 80 includes, for example, a steering wheel 82, an accelerator pedal 84, a brake pedal 86, an operation switch of a direction indicator, a shift lever, and other operators. A sensor that detects an amount of operation or whether an operation has been performed is attached to the driving operator 80. Results of detection of the sensor are output to the driving support device 100 or output to some or all of the travel driving force output device 200, the brake device 210, and the steering device 220. The steering wheel 82 is an example of a “steering operator.” The accelerator pedal 84 and the brake pedal 86 are an example of a “speed operator.”

For example, a steering wheel sensor (a SW sensor) 82A or a vibrator 36 for causing a part grasped by a driver to vibrate is provided in the steering wheel 82. The SW sensor 82A detects whether the driver touches the steering wheel 82. The SW sensor 82A detects an amount of operation (an amount of steering torque, an amount of steering, or a steering change rate) of the steering wheel which varies according to a driver's operation (hereinafter referred to as a steering operation) on the steering wheel 82. The SW sensor 82A may detect whether the driver grasps the steering wheel 82. The steering wheel 82 does not have to have a ring shape and may have a shape of a deformed steering wheel, a joystick, a button, or the like. In this case, the SW sensor 82A detects an amount of operation corresponding to each shape.

An accelerator pedal sensor (an AP sensor) 84A is provided in the accelerator pedal 84. The AP sensor 84A detects a driver's ON/OFF operation (hereinafter referred to as an accelerator operation) on the accelerator pedal 84 or an amount of operation (a change of an amount of operation or a rate of change of an amount of operation) of the accelerator pedal 84 which varies according to the operation thereon. A brake pedal sensor (a BP sensor) 86A is provided in the brake pedal 86. The BP sensor 86A detects a driver's ON/OFF operation (hereinafter referred to as a brake operation) on the brake pedal 86 or an amount of operation (a change of an amount of operation or a rate of change of an amount of operation) of the brake pedal 86 which varies according to the operation thereon. The accelerator operation and the brake operation are an example of a “speed operation.”

The travel driving force output device 200 outputs a travel driving force (a torque) for allowing the vehicle M to travel to driving wheels. The travel driving force output device 200 includes, for example, a combination of an internal combustion engine, an electric motor, and a transmission and an electronic control unit (ECU) that controls them. The ECU controls the aforementioned constituents on the basis of information input from the driving support device 100 or information input from the driving operator 80.

The brake device 210 includes, for example, a brake caliper, a cylinder that transmits a hydraulic pressure to the brake caliper, an electric motor that generates a hydraulic pressure in the cylinder, and an ECU. The ECU controls the electric motor on the basis of the information input from the driving support device 100 or the information input from the driving operator 80 such that a brake torque based on a brake operation is output to vehicle wheels. The brake device 210 may include a mechanism for transmitting a hydraulic pressure generated by an operation of the brake pedal 86 included in the driving operator 80 to the cylinder via a master cylinder as a backup. The brake device 210 is not limited to the above-mentioned configuration, and may be an electronically controlled hydraulic brake device that controls an actuator on the basis of information input from the driving support device 100 such that the hydraulic pressure of the master cylinder is transmitted to the cylinder.

The steering device 220 includes, for example, a steering ECU and an electric motor. The electric motor changes a direction of turning wheels, for example, by applying a force to a rack-and-pinion mechanism. The steering ECU drives the electric motor on the basis of the information input from the driving support device 100 or the information input from the driving operator 80 and changes the direction of the turning wheels.

### Driving Support Device

The driving support device 100 includes, for example, a recognizer 110, a driving state detector 120, a determiner 130, a controller 140, and a storage 150. The recognizer 110, the driving state detector 120, the determiner 130, and the controller 140 are realized, for example, by causing a hardware processor such as a central processing unit (CPU) to execute a program (software). Some or all of these constituents may be realized by hardware (a circuit part including circuitry) such as a large scale integration (LSI) device, an application-specific integrated circuit (ASIC), or a field-programmable gate array (FPGA), a graphics processing unit (GPU), or a system on chip (SOC) or may be cooperatively realized by software and hardware. The program may be stored in a storage device (a storage device including a non-transitory storage medium) such as an HDD or a flash memory of the driving support device 100 in advance, or may be stored in a removable storage medium such as a DVD or a CD-ROM and installed in the HDD or the flash memory of the driving support device 100 by setting the storage medium (a non-transitory storage medium) into a drive device.

For example, settings are set in the travel driving force output device 200, the brake device 210, and the steering device 220 such that instructions from the driving support device 100 to the travel driving force output device 200, the brake device 210, and the steering device 220 are performed more preferentially than those of the results of detection from the driving operator 80. Regarding braking, when a braking force based on an amount of operation on the brake pedal 86 is larger than that of an instruction from the driving support device 100, settings may be set such that braking using the braking force based on the amount of operation is preferentially performed. As a means for preferentially performing an instruction from the driving support device 100, communication priority in an on-board local area network (LAN) may be used.

The storage 150 may be realized by the aforementioned various storage devices, a solid-state drive (SSD), an electrically erasable programmable read only memory (EEPROM), a read only memory (ROM), a random access memory (RAM), or the like. For example, programs and various types of other information are stored in the storage 150. The aforementioned map information 54 may be stored in the storage 150.

The recognizer 110 recognizes a surrounding situation of the vehicle M on the basis of information input from an outside detection device. For example, the recognizer 110 recognizes states such as a position, a speed, and an acceleration of an object near the vehicle M (for example, within a predetermined distance (a first predetermined distance) from the vehicle M). Examples of the object include traffic participants such as another vehicle, a bicycle, and a pedestrian and road structures such as curbstones, median strips, and guardrails. For example, a position of an object is recognized as a position in an absolute coordinate system with a representative point (such as the center of gravity or the center of a drive shaft) of the vehicle M as an origin and is used for control. A position of an object may be expressed as a representative point such as the center of gravity or a corner of the object or may be expressed as an area. When an object is a mobile object, a “state” of the object may include an acceleration or a jerk of the object or a “moving state” (for example, whether lane change is being performed or whether lane change is going to be performed) thereof. The recognizer 110 recognizes a position or a speed relative to an object.

The recognizer 110 recognizes, for example, a lane (a traveling lane) in which the vehicle M is traveling. For example, the recognizer 110 performs a known analysis process (for example, edge extraction, feature extraction, or a pattern matching process) on an image (hereinafter referred to as a camera image) captured by the camera 10 and recognizes a position or a pattern of marking lines (for example, arrangement of a solid line and a dotted line) near the vehicle M from the analysis result. The recognizer 110 may recognize a position or a pattern of marking lines near the vehicle M with reference to map the map information 54 on the basis of the position information of the vehicle M. The recognizer 110 may recognize the traveling lane using at least one of a position or a pattern of marking lines acquired from the camera image and a position or a pattern of marking lines acquired from the map information. The recognizer 110 may recognize the traveling lane by recognizing traveling lane boundaries (road boundaries) including roadsides, curbstones, median strips, and guard rails in addition to the marking lines. In this recognition, the position of the vehicle M acquired from the navigation device 50 or the result of processing from the INS may be considered. The recognizer 110 may recognize a neighboring lane adjacent to the traveling lane. The recognizer 110 may recognize a radius of curvature (or a curvature), a gradient, a width, and the like of the traveling lane (or a road) from at least one of the camera image and the map information. The recognizer 110 recognizes an obstacle, a stop line, a red signal, a toll gate, or other road events from recognition results of objects. The obstacle is an object which the vehicle M needs to avoid collision with, and an example thereof is another vehicle.

The recognizer 110 may recognize a position or a posture of the vehicle M with respect to the traveling lane. The recognizer 110 may recognize, for example, a degree of separation of a reference point of the vehicle M from the lane center and an angle of the traveling direction of the vehicle M with respect to a line formed by connecting the lane centers as the position and the posture of the vehicle M with respect to the traveling lane. Instead, the recognizer 110 may recognize a position of a reference point of the vehicle M with respect to one side line of the traveling lane (a road marking or a road boundary) or the like as the relative position of the vehicle M with respect to the traveling lane. The recognizer 110 may recognize a position or a posture of another vehicle traveling in the traveling lane of the vehicle M or recognize whether another vehicle is located on the center side or on the marking line side of the traveling lane when seen from the vehicle M.

The driving state detector 120 detects a driving state of a driver of the vehicle M. The driving state includes, for example, a driving state of the vehicle M based on a driver's operation and a driving state of the vehicle M based on driving control of the controller 140. The driving state detector 120 includes, for example, a speed operation detector 122. The speed operation detector 122 detects, for example, a speed operation of the vehicle M (an operation for adjusting (changing) a speed of the vehicle M) performed by the driver. For example, the speed operation detector 122 detects start (ON state) or end (OFF state) of an accelerator operation of the driver or detects an amount of operation on the accelerator pedal 84 on the basis of the result of detection from the AP sensor 84A. The speed operation detector 122 detects start or end of a brake operation of the driver or detects an amount of operation on the brake pedal 86 on the basis of the result of detection from the BP sensor 86A. The speed operation detector 122 may detect a change of speed (acceleration) of the vehicle M in response to the speed operation performed by the driver on the basis of the result of detection from the vehicle sensor 40.

The driving state detector 120 may detect a driver's steering operation (a lane keeping steering operation) for keeping a state in which the vehicle M is in the traveling lane (for causing the vehicle M not to depart from the lane). For example, when a steering operation in which a steering torque detected by the SW sensor 82A is in a predetermined range is continuously performed within a predetermined time (a first predetermined time) or more, the driving state detector 120 detects the driver's lane keeping steering operation. For example, on the basis of a steering operation and change of a distance between right and left marking lines of the vehicle M and the vehicle M, the driving state detector 120 may detect the driver's lane keeping steering operation when the vehicle M is traveling at the lane center through the steering operation.

The driving state detector 120 may detect whether the driver is in a predetermined state on the basis of an image captured by the driver monitoring camera 70. The predetermined state may be, for example, a state in which the driver sees a forward view (or the surrounding of the vehicle M) or a state in which driving control by the system of the vehicle M can be rapidly handed over to the driver's manual driving. The driver's seeing a forward view means, for example, that the driver's gaze based on an analysis result of the image captured by the driver monitoring camera 70 is directed to a side in front of (in a traveling direction of) the vehicle M.

The driving state detector 120 may detect a state in which the driver does not perform a driving operation (the driver does not touch the driving operator 80) or a state in which the driver's driving operation is reduced (that is, a careless driving state) on the basis of detection results from the SW sensor 82A, the AP sensor 84A, and the BP sensor 86A or a driver state included in the image captured by the driver monitoring camera 70. The driving state detector 120 may detect a type of automatic driving control which is performed by the controller 140.

The determiner 130 includes, for example, a road situation determiner 132 and a departure determiner 134. The road situation determiner 132 determines a road situation in which the vehicle M travels. For example, the road situation determiner 132 determines whether there is a curved road within a predetermined distance (a second predetermined distance) in the traveling direction of the vehicle M on the basis of the result of recognition from the recognizer 110. For example, when a radius of curvature within the predetermined distance in the traveling direction in the traveling lane of the vehicle M is less than a threshold value (a first threshold value), the road situation determiner 132 determines that there is a curved road in the traveling lane. The road situation determiner 132 may use a curvature instead of the radius of curvature in determining of a curved road. The road situation determiner 132 may determine whether the vehicle M is traveling on a curved road at the current time point on the basis of the radius of curvature or the curvature of the traveling lane acquired through the aforementioned method. The road situation determiner 132 may determine whether a lane in the traveling direction of the vehicle M is straight on the basis of the radius of curvature or the curvature.

The departure determiner 134 determines whether the vehicle M is likely to depart from the traveling lane. For example, the departure determiner 134 determines whether the vehicle M is likely to depart from the traveling lane on the basis of a positional relationship between the right and left marking lines defining the traveling lane of the vehicle M recognized by the recognizer 110 and the vehicle M and the traveling direction or the speed of the vehicle M. The departure determiner 134 may determine whether the vehicle M is departing from the traveling lane at the current time point.

The controller 140 controls various functions or devices of the vehicle M. For example, the controller 140 alarms (notifies) an occupant (including a driver) of the vehicle M or performs driving control for controlling at least one of a speed and steering of the vehicle M on the basis of information acquired from the communication device 20, the HMI 30, the vehicle sensor 40, the driver monitoring camera 70, and the like, information detected by the SW sensor 82A, the AP sensor 84A, and the BP sensor 86A, the recognition result from the recognizer 110, the detection result from the driving state detector 120, the determination result from the determiner 130, and the like.

For example, when the departure determiner 134 determines that the vehicle M is likely to depart from the traveling lane, the controller 140 controls at least one of the HMI 30 and the steering device 220 such that control for curbing departure of the vehicle M from the traveling lane (lane departure curbing control) is performed. The lane departure curbing control is, for example, to perform (activate) at least one of control operations (a) to (c).
(a) The controller 140 causes the HMI 30 to output information (such as an image or sound) indicating that the vehicle M is likely to depart or that a driver is prompted to perform a steering operation or a speed operation for curbing the departure.
(b) The controller 140 causes the steering wheel 82 to vibrate using the vibrator 36.
(c) The controller 140 controls the steering device 220 (steering reaction control) such that the vehicle M returns to the center of the traveling lane (is maintained at a position in the lane).

The control of (a) may include control for turning on or blinking an output for outputting predetermined light instead of (or in addition to) outputting an image or sound. The control of (b) may include control for causing a seat on which a driver is sitting or a safety belt in use to vibrate instead of (or in addition to) causing the steering wheel 82 to vibrate. If the controller 140 performs the control of at least one of (a) and (b), it is an example of outputting of a “departure alarm.” Lane departure curbing control may include control for supporting the vehicle M or the driver such that the vehicle does not depart from the lane in addition to the aforementioned control. The controller 140 may perform control (alarm curbing control) for curbing outputting of a departure alarm according to the driving situation of the driver. Details of alarm curbing control will be described later.

The controller 140 may perform driving control such as adaptive cruise control system (ACC) control for causing the vehicle M to travel at a constant preset speed (a set vehicle speed) in the traveling lane, lane keeping assistance system (LKAS) control for causing the vehicle M to travel at the center of the traveling lane, or auto lane change (ALC) control for operating at least steering of the vehicle M to change the traveling lane of the vehicle M on the basis of a recognition result from the recognizer 110 or the like, a driver's instruction from the HMI 30, and the like. The controller 140 may perform various types of driving control such as collision mitigation brake system (CMBS) for performing brake control of the vehicle M by alarming the driver or emergency stop control for causing the vehicle M to stop at a safe position when the vehicle M is likely to collide with an obstacle. When this driving control is performed, the controller 140 performs automatic driving control for automatically controlling at least one of the steering and the speed of the vehicle M.

The controller 140 may notify an occupant (including a driver) of predetermined information through the HMI 30. The predetermined information includes, for example, information associated with traveling of the vehicle M such as information on the state of the vehicle M or information on driving control. The information on the state of the vehicle M includes, for example, a speed, an engine rotation speed, and a shift position of the vehicle M. The information on driving control includes, for example, a type of driving control under execution (a driving state), an operating reason of driving control, a situation of driving control, and information indicating that driving control has started or ended. The information on driving control may include an alarm of the driver and information for prompting performing a predetermined driving operation or attracting the attention of the driver. The predetermined information may include information on a current position or a destination of the vehicle M and a residual amount of fuel or may include information not associated with traveling control of the vehicle M such as television programs and content (for example, movies) stored in a storage medium such as a DVD.

For example, the controller 140 may generate an image including the predetermined information and display the generated image on the display 32 of the HMI 30 or may generate sound indicating the predetermined information and output the generated sound from the speaker 34 of the HMI 30. The timing at which sound is output is, for example, a timing at which driving control starts or stops, a timing of an incoming call, a timing at which a displayed image is switched, and a timing at which the vehicle M enters a predetermined state. The controller 140 causes the steering wheel 82, a seat, a safety belt, or the like to vibrate using the vibrator 36.

### Alarm Curbing Control

Details of alarm curbing control according to the present embodiment will be specifically described below. For example, the controller 140 performs alarm curbing control on the basis of the driving situation of the driver or the like such that the driver does not feel troublesome from excessive outputting of a departure alarm to hinder driving.

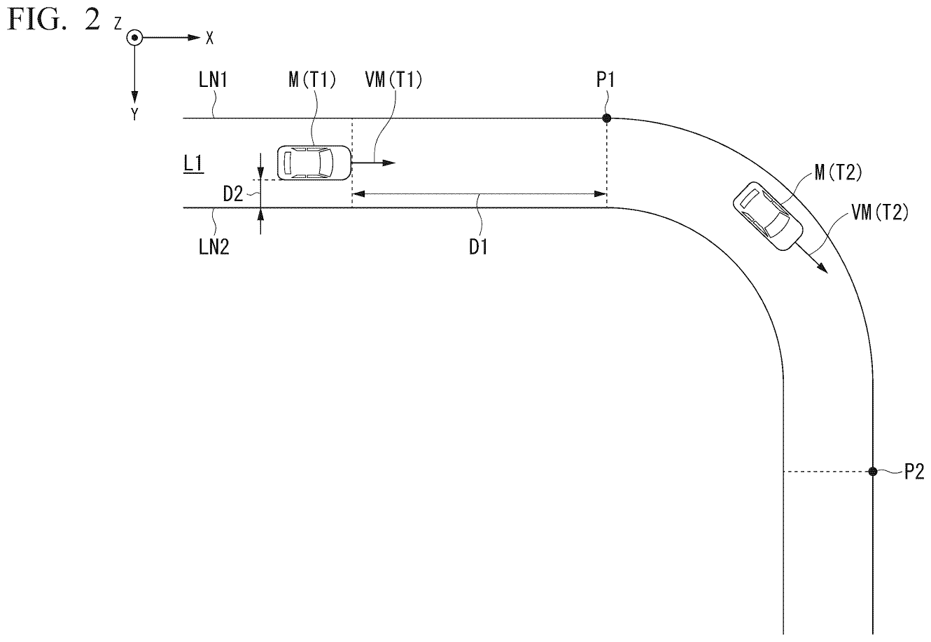

FIG. 2 is a diagram illustrating alarm curbing control according to the embodiment. In the example illustrated in FIG. 2, it is assumed that the vehicle M is traveling at a speed VM in a lane L1 defined by right and left marking lines LN1 and LN2. A partial section (a section between points P1 and P2 in the drawing) of the lane L1 includes a curved road with a radius of curvature which is less than a threshold value (a first threshold value). In the example illustrated in FIG. 2, a position of the vehicle M at time T* is defined as M(T*), and a speed thereof is defined as VM(T*). In the following description, it is assumed that times T1 and T2 are later in this order. It is assumed that the vehicle M is traveling through a driver's manual driving operation using the driving operator 80.

In the example illustrated in FIG. 2, the vehicle M continuously performs the processes of the driving state detector 120 and the determiner 130 at intervals or timing of a predetermined period during traveling. The speed operation detector 122 detects whether a brake operation or an accelerator operation is performed as a speed operation of the vehicle M by the driver. For example, in case of the brake operation, the speed operation detector 122 detects the speed operation when the brake operation is turned on. In case of the accelerator operation, the speed operation detector 122 detects the speed operation when a rate of change of an amount of operation in the accelerator operation is equal to or greater than a threshold value (a second threshold value) (or a change of the speed VM of the vehicle M based on the accelerator operation is equal to or greater than a threshold value (a third threshold value)). In case of the accelerator operation, by detecting the speed operation according to the embodiment depending on the rate of change of the amount of operation is equal to or greater than the threshold value, it is possible to distinguishably detect an accelerator operation for making the speed VM of the vehicle M constant and an accelerator operation for adjusting the speed (acceleration, deceleration). The threshold values (the second threshold value and the third threshold value) may be fixed values or may be variable values which are set according to the speed VM of the vehicle M, a road shape, or the like. A change of an amount of operation may be used instead of the rate of change of an amount of operation.

The speed operation based on the accelerator operation is not limited to a decelerating operation and may be an accelerating operation. For example, when a curved road is present in the traveling direction of the vehicle M as at time T1 in FIG. 2, a decelerating operation is normally assumed to be performed, but deceleration may be performed to avoid a nearby obstacle or the like and then acceleration may be performed to enter the curved road. Accordingly, in the present embodiment, that the driver is performing the speed operation is detected through deceleration or acceleration.

The road situation determiner 132 determines whether a road shape at the current position in the traveling lane is a curved road or whether a road shape at which the vehicle M arrives in the near future (a predetermined time (a second predetermined time)) is a curved road on the basis of the recognition result from the recognizer 110. When it is determined that there is a curved road in the traveling direction of the vehicle M, the road situation determiner 132 may derive a distance (that is, a distance from the curved road) D1 from the vehicle M to the curved road (a start point P1 of the curved road).

For example, the departure determiner 134 determines that the vehicle M is likely to depart from the traveling lane when there is a likelihood that a reference position (for example, an end, a center, or the center of gravity) of the vehicle M will go over one of the right and left marking lines of the traveling lane recognized by the recognizer 110 (pass through the marking line) and exceed the traveling lane and determines that the vehicle M is not likely to depart from the traveling lane when there is no likelihood that the reference position will exceed the lane.

The departure determiner 134 may employ different departure determination conditions according to the surrounding road situation of the vehicle M determined by the road situation determiner 132. For example, the departure determiner 134 determines that the vehicle M is likely to depart from the traveling lane when the traveling lane of the vehicle M is a straight lane (a straight road) (not a curved road) and a shortest distance D2 between a marking line of the traveling lane and the vehicle M is less than a predetermined distance (a third predetermined distance) and determines that the vehicle M is not likely to depart from the traveling lane when the shortest distance is equal to or greater than the predetermined distance.

When the traveling lane of the vehicle M is a curved road, the departure determiner 134 derives a future predicted trajectory of the vehicle M on the basis of the speed VM and the yaw rate of the vehicle M and calculates a margin time (time-to-line-crossing (TTLC) (=d/VM)) until the vehicle M arrives at the marking line on the basis of a distance between the derived predicted trajectory and the marking line (an arc) (a departure path length d) and the speed VM. Then, the departure determiner 134 determines that the vehicle M is likely to depart from the traveling lane when the margin time TTLC is less than the predetermined time (the third predetermined time) and determines that the vehicle M is not likely to depart from the traveling lane when the margin time TTLC is equal to or greater than the predetermined time. The departure determiner 134 may employ the same determination condition for the straight road as in the curved road and may employ the same determination condition for the curved road as in the straight road.

Processes at times T1 and T2 will be described below. For example, at time T1, it is assumed that the speed operation of the vehicle M performed by the driver is detected by the speed operation detector 122. In this case, the controller 140 acquires and stores the position of the vehicle M (the distance D1 from the curved road) when the speed operation has been detected.

Then, at time T2, for example, it is assumed that the departure determiner 134 determines that the vehicle M is likely to depart from the lane L1. At time T2, it is assumed that the speed operation is not performed. In this case, the controller 140 determines whether time T1 at which the speed operation has been detected is within a predetermined time (a fourth predetermined time) from time T2. When time T1 is within the predetermined time, the controller 140 curbs outputting of a departure alarm. The controller 140 may add a condition in which the position of the vehicle M (the distance D1 from the curved road) at which the speed operation has been detected is in the predetermined distance (the fourth predetermined distance) or a condition in which the vehicle M is traveling in the curved road to the aforementioned condition of the predetermined time. When this condition is satisfied, the controller 140 curbs outputting of a departure alarm.

If outputting of a departure alarm is curbed, it means, for example, that the control of both of (a) and (b) included in the lane departure curbing control is performed in general, but at least one thereof is not performed in this case. For example, speed adjustment based on a decelerating operation, an accelerating operation, or the like may be performed by a certain driver before entering the curved road. When a departure alarm is output in this case, the driver may feel troublesome from the alarm. Accordingly, in the embodiment, when a speed operation is performed at a predetermined timing (in the fourth predetermined time) before entering the curved road, the driver is estimated to recognize the curved road in advance, and outputting of a departure alarm is curbed even if it is determined that the vehicle M is likely to depart from the traveling lane in the curved road. Accordingly, it is possible to realize more appropriate departure curbing control according to the driving situation of the driver.

When outputting of a departure alarm is curbed, the controller 140 may not perform reaction control in the control of (c) or may perform reaction control. By performing reaction control even if outputting of an alarm is curbed, it is possible to curb a driver feeling troublesome from the alarm and to more safely drive the vehicle M through the reaction control.

The predetermined time (the fourth predetermined time) may be a fixed time or may be a variable time which can vary according to a road shape (for example, a radius of curvature of a curved road or a lane width) or the speed VM of the vehicle M. The predetermined time may derive a time required until the vehicle M departs from the curved road after a decelerating operation based on the accelerator operation or the brake operation has been completed, for example, on the basis of statistical results of past speed adjustment histories including other vehicles in the current curved road and set a time corresponding to the derived time.

For example, it preferable that the predetermined time (the fourth predetermined time) be set to the same time when the accelerator operation has been detected and when the brake operation has been detected. For example, when the brake operation has ended before the curved road, deceleration has been completed in general, and thus the predetermined time after the brake operation has been completed is considered to be a margin time. However, when it is intended to decelerate the vehicle through only turning off the accelerator in the curved road, it is conceivable that a likelihood that deceleration will not be sufficient increases in comparison with a case in which the brake operation is performed. For the purpose of coping therewith, it is also conceivable that the predetermined time in accelerator operation be set to be shorter than the predetermined time in the brake operation, but it is estimated that the driver has recognized the curved road in advance in any of the brake operation and the accelerator operation. Accordingly, by controlling curbing of an alarm in the same condition, it is possible to curb a trouble due to the alarm and to curb a user feeling discomfort due to different curbing times. In the embodiment, the predetermined time (the fourth predetermined time) may be set to be variable according to the accelerator operation and the brake operation. In this case, the predetermined time in the accelerator operation is set to be shorter than that in the brake operation.

In the aforementioned processes, the predetermined time (the fourth predetermined time) may be a time after the speed operation has been completed (for example, the brake operation has been turned off) instead of the time after the speed operation has been detected by the speed operation detector 122.

When the departure determiner 134 determines that the vehicle M is likely to depart from the lane L1 even after the predetermined time (the fourth predetermined time) has elapsed, the controller 140 performs lane departure curbing control including a departure alarm.

When the departure determiner 134 determines that the vehicle M is likely to depart from the lane L1 after a speed operation (for example, a decelerating operation) has been performed while traveling in the curved road, the controller 140 may perform alarm curbing control using the same conditions.

When the aforementioned conditions are satisfied, the controller 140 curbs only an alarm for lane departure and does not perform curbing in other control (for example, CMBS control for alarming the driver when the vehicle M is likely to collides with an obstacle). Accordingly, it is possible to output an alarm other than a lane departure alarm in more appropriate situations.

### Process Flow

An example of a process flow that is performed by the driving support device 100 according to the embodiment will be described below with reference to the flowcharts. In the following example, a process flow of curbing a departure alarm in lane departure curbing control based on a driver's speed operation out of process flows performed by the driving support device 100 will be mainly described. Accordingly, the following process flow represents a process flow in a situation in which lane change control or the like is not performed. In the following description, control in the brake operation of the driver and control in the accelerator operation of the driver will be divisionally described. The following process flow may be performed repeatedly at intervals or timings of a predetermined period.

### First Example: Alarm Curbing Process Based on Brake Operation

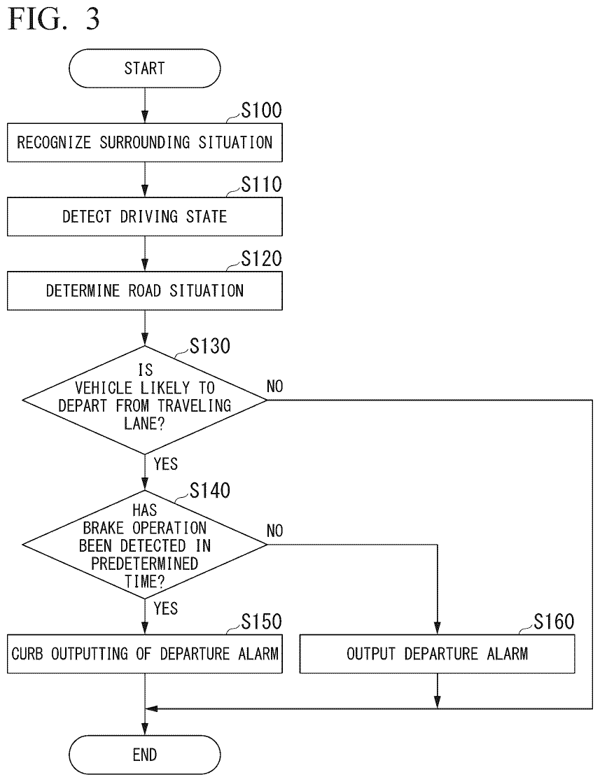

FIG. 3 is a flowchart illustrating a first example of an alarm curbing process. The process flow in FIG. 3 is an alarm curbing process based on the brake operation. In the example illustrated in FIG. 3, the recognizer 110 recognizes a surrounding situation of a vehicle M (Step S100). Then, the driving state detector 120 detects a driving state of the vehicle M or the driver (Step S110). Then, the road situation determiner 132 determines a road situation in the traveling direction of the vehicle M (Step S120). In the process of Step S120, the road situation determiner 132 may determine, for example, when a road in the traveling direction of the vehicle M is a curved road (a straight road).

Then, it is determined whether the vehicle M is likely to depart from the traveling lane (Step S130). When it is determined that the vehicle M is likely to depart from the traveling lane, the controller 140 determines whether a brake operation has been detected within a predetermined time by the speed operation detector 122 (Step S140). When it is determined that a brake operation has been detected within the predetermined time, the controller 140 curbs outputting of a departure alarm (Step S150). When it is determined that a brake operation has not been detected within the predetermined time, the controller 140 outputs a departure alarm (Step S160). In this way, this routine of the flowchart ends.

### Modified Example of First Example

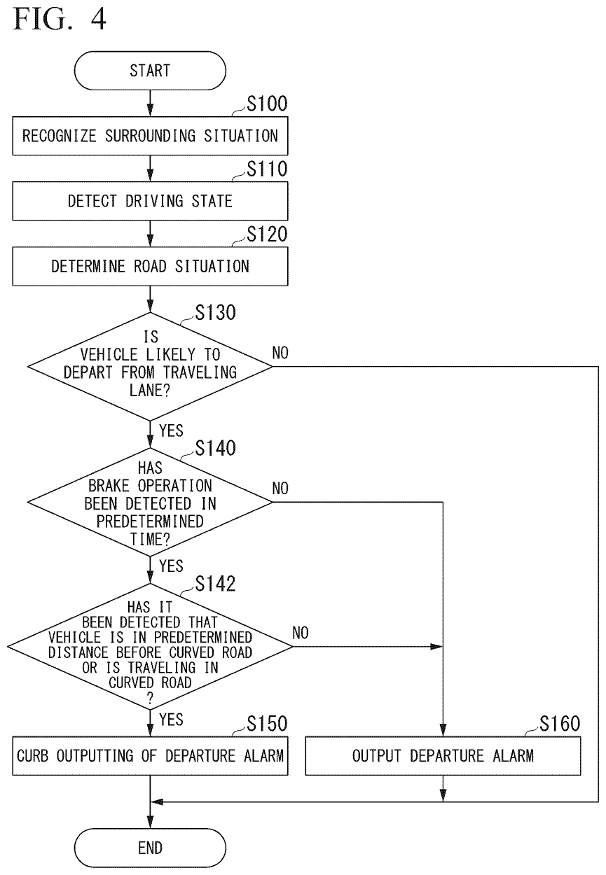

In the process flow illustrated in FIG. 3, the controller 140 may add a condition based on a road situation of the vehicle M in which the brake operation has been performed. FIG. 4 is a flowchart illustrating a modified example of the departure alarm curbing process according to the first example. The process flow illustrated in FIG. 4 is a different from the process flow illustrated in FIG. 3, in that Step S142 is further included between Step S140 and Step S150 in addition to the processes of Steps S100 to S160. In the following description, the different processes will be mainly described.

When it is determined in the process of Step S140 in FIG. 4 that a brake operation has been detected within the predetermined time, the controller 140 determines whether the brake operation has been detected while the vehicle M is traveling at a position within a predetermined distance before a curved road or traveling in the curved road (Step S142). When it is determined that the brake operation has been detected while the vehicle M is traveling at a position within a predetermined distance before a curved road or traveling in the curved road, the controller 140 curbs outputting of a departure alarm (Step S150). When it is determined in the process of Step S142 that the brake operation has not been detected while the vehicle M is traveling at a position within a predetermined distance before a curved road or traveling in the curved road, the controller 140 outputs a departure alarm (Step S160).

According to the modified example of the first example, for example, when a brake operation has been performed at a position before the curved road, the driver is estimated to decelerate the vehicle M to travel on the curved road in front (that is, the driver is estimated to recognize the curved road), and thus it is possible to curb an excessive alarm for the driver by curbing outputting of a departure alarm in that case.

### Second Example: Departure Alarm Curbing Process Based on Accelerator Operation

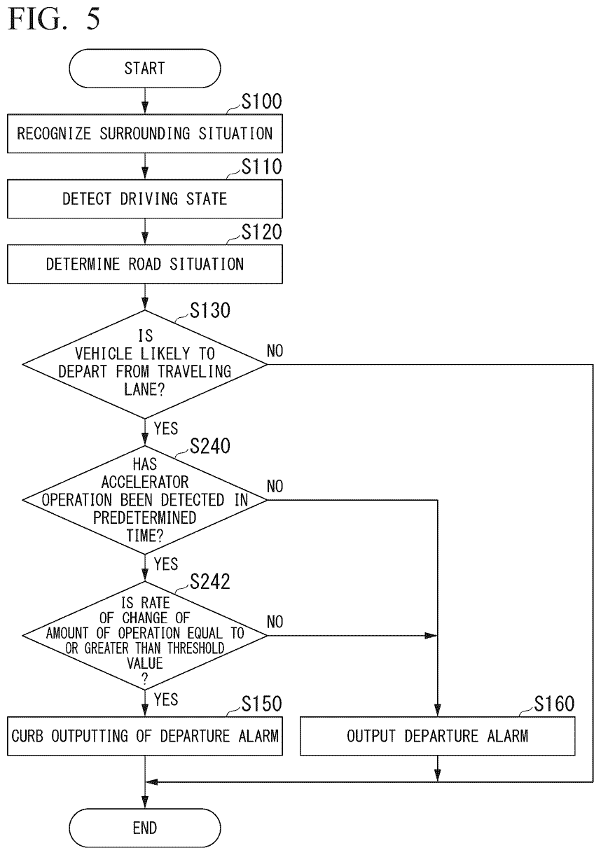

FIG. 5 is a flowchart illustrating a second example of the departure alarm curbing process. The process flow illustrated in FIG. 5 is a departure alarm curbing process based on an accelerator operation. The process flow illustrated in FIG. 5 is different from the process flow illustrated in FIG. 3, in that Steps S240 and S242 are further included instead of the process of Step S140 out of Steps S100 to S160. Accordingly, the processes of Steps S240 and S242 will be mainly described below.

When it is determined in the process of Step S130 illustrated in FIG. 5 that the vehicle M is likely to depart from the traveling lane, the controller 140 determines whether an accelerator operation has been detected within a predetermined time by the speed operation detector 122 (Step S240). When it is determined that an accelerator operation has been detected within the predetermined time, the controller 140 determines whether a rate of change of an amount of operation (a change of the amount of operation) in the accelerator operation is equal to or greater than a threshold value (Step S242). When it is determined that the rate of change of the amount of operation is equal to or greater than the threshold value, the controller 140 curbs outputting of a departure alarm (Step S150). When it is determined that the rate of change of the amount of operation is not equal to or greater than the threshold value, the controller 140 outputs a departure alarm (Step S160). In this way, this routine of the flowchart ends.

### Modified Example of Second Example

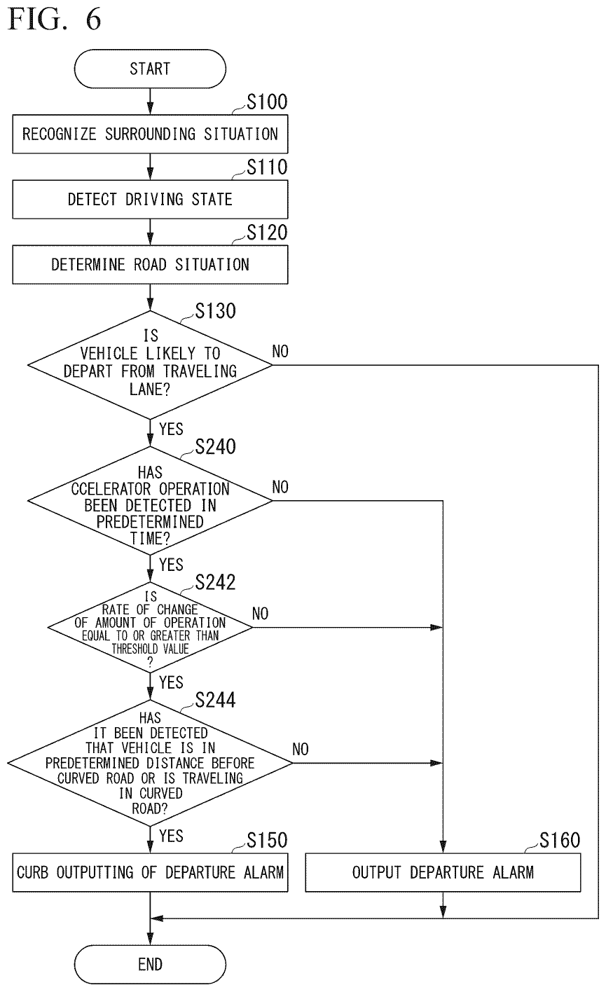

In the process flow illustrated in FIG. 5, the controller 140 may add a constraint condition based on a road situation of the vehicle M in which the accelerator operation has been performed. FIG. 6 is a flowchart illustrating a modified example of the departure alarm curbing process according to the second example. The process flow illustrated in FIG. 6 is a different from the process flow illustrated in FIG. 5, in that Step S244 is further included between Step S242 and Step S150 in addition to the processes of Steps illustrated in FIG. 5. In the following description, the different processes will be mainly described.

When it is determined in the process of Step S242 in FIG. 6 that the rate of change of the amount of operation is equal to or greater than the threshold value, the controller 140 determines whether the accelerator operation has been detected while the vehicle M is traveling at a position within a predetermined distance before a curved road or traveling in the curved road (Step S244). When it is determined that the accelerator operation has been detected while the vehicle M is traveling at a position within a predetermined distance before a curved road or traveling in the curved road, the controller 140 curbs outputting of a departure alarm (Step S150). When it is determined in the process of Step S244 that the accelerator operation has not been detected while the vehicle M is traveling at a position within a predetermined distance before a curved road or traveling in the curved road, the controller 140 outputs a departure alarm (Step S160).

According to the modified example of the second example, for example, when an accelerator operation has been performed at a position before the curved road, the driver is estimated to decelerate the vehicle M to travel on the curved road in front (that is, the driver is estimated to recognize the curved road), and thus it is possible to curb an excessive alarm for the driver by curbing outputting of a departure alarm in that case.

### MODIFIED EXAMPLES

In the embodiment, the controller 140 may perform alarm curbing control associated with a departure alarm on the basis of a steering operation detected by the driving state detector 120 in addition to the speed operation performed by the driver. In this case, for example, when a lane keeping steering operation for keeping a state in which the vehicle M is in the lane in addition to the speed operation has been detected at a position before the vehicle M enters the curved road, the controller 140 curbs outputting of a departure alarm even if it is determined that the vehicle M is likely to depart from the traveling lane. In this way, by curbing outputting of a departure alarm when both conditions of speed and steering are satisfied, it is possible to more reliably ascertain that the driver is adjusting the speed or the steering such that the vehicle does not depart from the lane and thus to curb outputting of a departure alarm. Accordingly, it is possible to perform (activate) a departure alarm in more appropriate situations.

In the embodiment, alarm modes of the departure alarm in a road (for example, a straight road) other than a curved road and the departure alarm in the curved road may be set to be different. For example, in case of a straight road, since it is thought that the vehicle M becomes closer to a marking line slowly, the controller 140 outputs an alarm which is stepwise strengthened as the distance from the marking line becomes shorter. In this case, the controller 140 performs only the control of (a) included in the lane departure curbing control at the first time and performs the control of both (a) and (b) at the second time. On the other hand, in case of a curved road, since the marking line has a curvature, the vehicle M is more likely to depart from the lane without changing the steering of the vehicle M. Accordingly, at the time of outputting of a departure alarm in case of a curved road, the controller 140 performs the control of both (a) and (b) in one departure alarm. Accordingly, it is possible to output a more appropriate departure alarm according to a road situation.

As described above, the vehicle control device according to the embodiment includes the recognizer 110 configured to recognize a surrounding situation of a vehicle M, the speed operation detector 122 configured to detect a speed operation on the vehicle M performed by a driver of the vehicle M, the determiner 130 configured to determine whether the vehicle M is likely to depart from a traveling lane on the basis of the recognition result from the recognizer 110, and the controller 140 configured to output a departure alarm to the driver when the determiner 130 determines that the vehicle M is likely to depart from the traveling lane, and the controller 140 curbs outputting of the departure alarm when a predetermined time has not elapsed after the speed operation has been detected by the speed operation detector 122. Accordingly, it is possible to perform more appropriate departure curbing control according to a driving situation of the driver. As a result, it is possible to further contribute to advancement of a sustainable transportation system.

For example, according to the embodiment, it is possible to curb an occupant feeling troublesome by estimating that a driver recognizes a curved road through the driver's speed adjusting operation in the vicinity of the curved road and curbing outputting of a departure alarm within a predetermined time.

The above-mentioned embodiment can be expressed as follows:

A vehicle control device comprising:
a storage medium configured to store computer-readable instructions; and
a processor connected to the storage medium,
wherein the processor executes the computer-readable instructions to perform:
recognizing a surrounding situation of a vehicle;
detecting a speed operation on the vehicle performed by a driver of the vehicle;
determining whether the vehicle is likely to depart from a traveling lane on the basis of the recognized surrounding situation;
outputting a departure alarm to the driver when it is determined that the vehicle is likely to depart from the traveling lane; and
curbing outputting of the departure alarm when a predetermined time has not elapsed after the speed operation has been detected.

While an embodiment of the present invention has been described above, the present invention is not limited to the embodiment and can be subjected to various modifications and substitutions without departing from the gist of the present invention.

What is claimed is:

1. A vehicle control device comprising:
a recognizer configured to recognize a surrounding situation of a vehicle;
a speed operation detector configured to detect a speed operation on the vehicle performed by a driver of the vehicle;
a determiner configured to determine whether the vehicle is likely to depart from a traveling lane on the basis of a recognition result from the recognizer; and
a controller configured to output a departure alarm to the driver when the determiner determines that the vehicle is likely to depart from the traveling lane,
wherein the controller curbs outputting of the departure alarm when a predetermined time has not elapsed after the speed operation has been detected by the speed operation detector.

2. The vehicle control device according to claim 1, wherein the controller curbs outputting of the departure alarm when the predetermined time has not elapsed after the speed operation has been detected while the vehicle is within a predetermined distance before a curved road or is traveling on a curved road and it is determined that the vehicle is likely to depart from the traveling lane.

3. The vehicle control device according to claim 1, wherein the speed operation detector detects the speed operation when a brake operation on the vehicle is performed by the driver.

4. The vehicle control device according to claim 1, wherein the speed operation detector detects the speed operation when an accelerator operation on the vehicle is performed by the driver and a rate of change of an amount of operation on an accelerator pedal in the accelerator operation is equal to or greater than a threshold value.

5. The vehicle control device according to claim 1, wherein the controller curbs outputting of the departure alarm when the predetermined time has not elapsed after the speed operation has been completed and it is determined that the vehicle is likely to depart from the traveling lane.

6. The vehicle control device according to claim 1, wherein the speed operation includes a brake operation and an accelerator operation on the vehicle, and
wherein the predetermined time is set to the same time for the brake operation and the accelerator operation.

7. A vehicle control method that is performed by a computer, the vehicle control method comprising:
recognizing a surrounding situation of a vehicle;
detecting a speed operation on the vehicle performed by a driver of the vehicle;
determining whether the vehicle is likely to depart from a traveling lane on the basis of the recognized surrounding situation;
outputting a departure alarm to the driver when it is determined that the vehicle is likely to depart from the traveling lane; and
curbing outputting of the departure alarm when a predetermined time has not elapsed after the speed operation has been detected.

8. A non-transitory computer-readable storage medium storing a program, the program causing a computer to perform:
recognizing a surrounding situation of a vehicle;
detecting a speed operation on the vehicle performed by a driver of the vehicle;
determining whether the vehicle is likely to depart from a traveling lane on the basis of the recognized surrounding situation;
outputting a departure alarm to the driver when it is determined that the vehicle is likely to depart from the traveling lane; and
curbing outputting of the departure alarm when a predetermined time has not elapsed after the speed operation has been detected.
